(19) United States
(12) Patent Application Publication
(10) Pub. No.: US 2003/0167411 A1
(43) Pub. Date: Sep. 4, 2003

(54) Communication monitoring apparatus and monitoring method

(75) Inventor: Yukako Maekawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/350,086

(22) Filed: Jan. 24, 2003

(30) Foreign Application Priority Data
Jan. 24, 2002 (JP) 2002-016194

(51) Int. Cl. H04L 9/00

(52) U.S. Cl. 713/201

(57) ABSTRACT

A monitoring apparatus and a monitoring method to monitor communications between computers having unique identifiers and thereby improve security without increasing the administrative load of a manager.

A communication monitoring unit monitors the identifiers included in the communications of computers. If the identifier is not stored in a storage unit as a computer acknowledged to conduct a communication, an authentication procedure is executed. If the authentication procedures are not completed normally, an alarm generating unit notifies an alarm to a manager under the supposition that the computer has conducted an unauthorized a communication. When the authentication procedures are completed normally, the identifier is stored in the identifier storage unit under the supposition that the computer is acknowledged to conduct a communication.

### CROSS-REFERENCE TO RELATED APPLICATIONS

This application claims the benefit of Japanese Application No. 2002-016194, filed Jan. 24, 2002, in the Japanese Patent Office, the disclosure of which is incorporated herein by reference.

### BACKGROUND OF THE INVENTION

1. Field of the Invention

The present invention relates to a communication monitoring apparatus and a monitoring method to quickly detect a connection to a network of computers in a system in which a computer to be connected to the network automatically establishes the connection to the network.

2. Description of the Related Art

Systems which utilize a network based on Transmission Control Protocol/Internet Protocol (TCP/IP) are wide spread. A TCP/IP network connection is established by designating the individual IP address for each computer and setting a subnet mask, which is an IP address of the gateway and an IP address of the domain name server. Therefore, where many computers are connected to the TCP/IP network, the TCP/IP network must be set or configured individually to all computers requiring significant processing just to maintain network setting or configuration information.

The Dynamic Host Configuration Protocol (DHCP) is a specification for automatically establishing network settings that can alleviate the load caused by maintaining network settings. A DHCP server automatically sends network setting information, such as, for example, an Internet Protocol (IP) address, to a computer that desires connection to the TCP/IP network and each computer automatically sets up or configures the network based on the setting information. Therefore, a load caused by the configuration work for network connection of each computer can be greatly reduced. Moreover, when the IP addresses are statically assigned to each computer without using DHCP, the other computers cannot use the same IP addresses assigned to such computer even if the computer is not connected to that network. Instead, using DHCP, the limited number of IP addresses can be dynamically assigned to use different IP addresses for the same device.

Since the TCP/IP network configuration can only be established by physically connecting the computer to the network, a computer that is newly connected to a system can easily utilize the TCP/IP network. Meanwhile, a network manager cannot detect that such computer utilizes the TCP/IP network. As a result, there is a risk that the TCP/IP network can be impermissibly used and a computer virus or a computer worm could enter the TCP/IP network from the computer which is not supervised by a network manager.

Japanese Unexamined Patent Application Publication No.1995-264178 discloses a system in which a repeater monitors and relays frames of communications when a previously registered communication frame which is not acknowledged is received. A notification indicating reception of this frame is sent to a management apparatus. However, a manager is requested to register the acknowledged communication frames and the frames not acknowledged to the repeater.

Japanese Unexamined Patent Application Publication No. 2000-59387 discloses a DHCP server conducting automatic setup of the network with DHCP to a client. The DHCP server confirms a host name of the client that has requested the automatic setup, compares this confirmed host name with the host name which is acknowledged to make the automatic setup with the DHCP registered to the DHCP server and, when these host names match, conducts the automatic setup for the client. However, unlike a password, the host name cannot be kept secret. Moreover, since the host name which is acknowledged to conduct automatic setup in order to monitor the network can be estimated or determined easily, security is insufficient. In addition, the DHCP server is also requested to previously set the host name which is acknowledged to conduct the automatic setup and to individually set the host name acknowledged to conduct the automatic setup to the client.

### SUMMARY OF THE INVENTION

A DHCP server can prohibit access of computers outside of management control by utilizing a unique and fixed MAC (Media Access Control) address assigned to the computer or to peripheral apparatuses of the computer network. The MAC addresses of all apparatuses which are automatically set with DHCP are registered with the DHCP server. This DHCP server provides the automatic setup with the DHCP only to computers or peripheral devices having previously registered MAC addresses in the computer network. As a result, if the computer does not have a registered MAC address, the DHCP server does not allow the device to use the TCP/IP network. The network manager detects MAC addresses of all devices which can use the TCP/IP network and sets up such addresses with the DHCP server. If a user of the network connects a new apparatus to the TCP/IP network, this user is requested to register the MAC address of this new device to the DHCP server prior to using the network for other communication.

The present invention relates to a communication monitoring apparatus and a monitoring method for quickly detecting computers that are not within the network manager's control in a network system in which the network connection settings are automatically executed for the computers connected in the network.

### BRIEF DESCRIPTION OF THE DRAWINGS

FIG. 1 is a schematic diagram explaining the present invention.

FIG. 2 is a schematic diagram of an embodiment of the present invention.

FIG. 3 is a schematic diagram of the monitoring apparatus of the present invention.

FIG. 4 is a schematic diagram of a client of the present invention.

FIG. 5 is a flowchart of the monitoring method of the present invention.

FIG. 6 is a flowchart of the authentication program of the present invention.

FIG. 7 is a schematic diagram of another embodiment of the present invention.

FIG. 8 is a schematic diagram of the DHCP server with the monitoring apparatus of the present invention.

FIG. 9 is a flowchart of the DHCP server with the monitoring method of the present invention.

### DETAILED DESCRIPTION OF THE PREFERRED EMBODIMENTS

Embodiments of the present invention will be explained in detail with reference to the accompanying drawings.

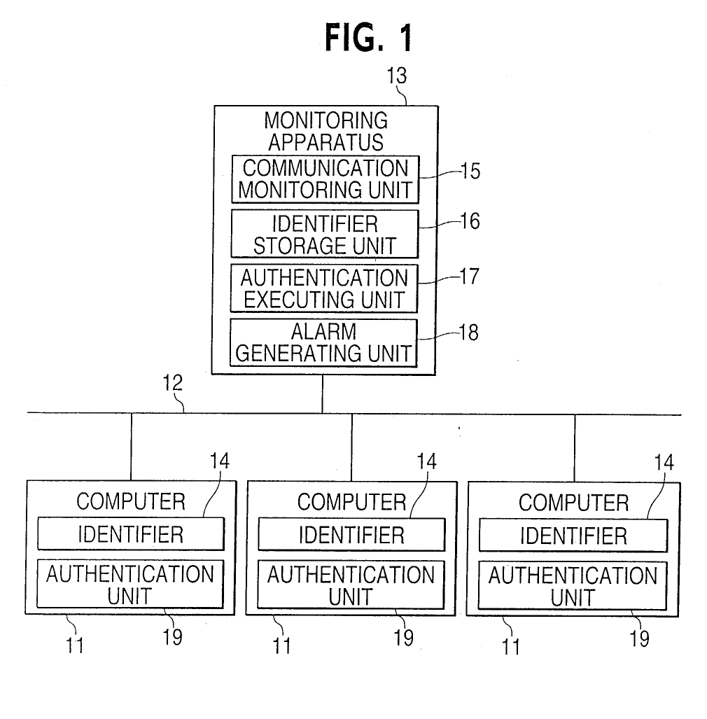

FIG. 1 is a schematic diagram for explaining the present invention. A monitoring apparatus 13 is connected to a communication network 12 in which a plurality of computers 11 are connected. Each computer 11 has a unique identifier 14 which is used for communication through the communication network 12. The monitoring apparatus 13 comprises a communication monitoring unit 15 monitoring communications of the computers 11 in the communication network 12, an identifier storage unit 16 storing identifiers of the computers 11 which are acknowledged by a manager to use the communication network 12, an authentication executing unit 17 executing authentication of the computers 11, and an alarm issuing unit 18 warning a manager of the communication network 12 of use of the network 12 by computers 11 which are not acknowledged to use the communication network 12. Each computer 11 using the communication network 12 is previously provided with an authentication unit 19 to execute authentication depending on an instruction from the authentication executing unit 17 of the monitoring apparatus 13.

A communication in the communication network 12 includes an identifier 14 of the computer 11 as a transmission originator or source and an identifier 14 of the computer 11 as a transmission terminator or destination. The communication monitoring unit 15 compares the identifier 14 of the computer as the transmission originator with the identifier 14 stored in the identifier storage unit 16 in which the identifiers 14 of the computers 11 are acknowledged by a manager of the communication network 12 to conduct the communications. If the identifier 14 of the computer as the transmission originator is stored in the identifier storage unit 16, the present communication is deemed to be an authorized communication between the computers 11 which are approved to communicate by a communication network manager. If the identifier 14 of the computer 11 as the transmission originator is not stored in the identifier storage unit 16, the authentication executing unit 17 instructs the computer 11 having this identifier to execute an authentication procedure. In addition to authenticating the computer 11 as the transmission originator, the identifier 14 of the computer as the transmission terminator may also be authenticated. If the authentication unit 19 cannot correctly authenticate the computer 11, the authentication executing unit 17 determines that the computer 11 is not authorized to use the communication network 12 and instructs the alarm issuing unit 18 to issue an alarm to a manager of the communication network 12. When the computer 11 is correctly authenticated, the identifier 14 of this computer 11 is newly stored in the identifier storage unit 16 under the supposition that the communication of this computer 11 is approved. As a result, the identifier comparing unit 16 determines, that the computer 11 is approved to use the communication network 12 and this computer is not authenticated with the authentication executing unit 17 even when this computer 11 uses the communication network 12 again.

As explained above, according to the present invention, the identifier 14 of the computer, which is approved to newly use the communication network 12, is automatically added to the identifier storage unit 16 as a result of the authentication of the computer 11 with the authentication executing unit 17 and the authentication unit 19. Thus, a manager of the communication network 12 can detect use of the communication network 12 by computers that are not approved or authorized to use the network.

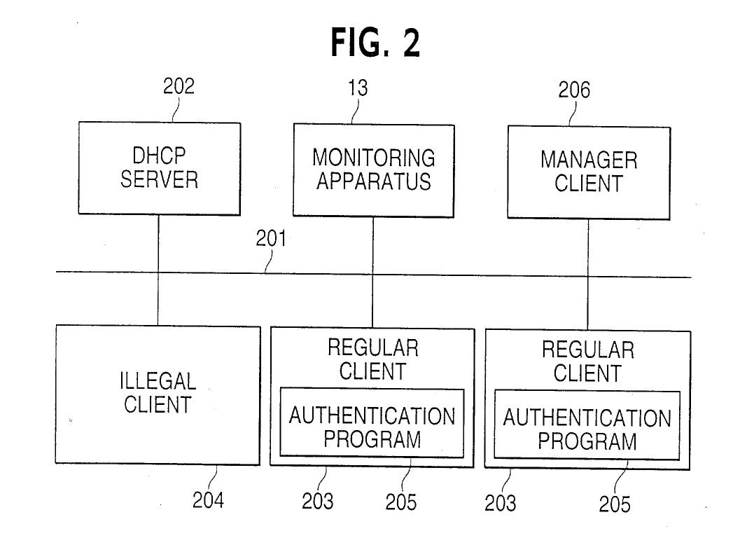

FIG. 2 is a schematic diagram of an embodiment of the present invention. The LAN (Local Area Network) 201 connects a plurality of computers and enable communication among these computers. In the example of FIG. 2, a DHCP server computer 202, a monitoring computer 13, a management client computer 206, an unauthorized client computer 204 and a recognized client computer 203 are connected to the local area network (LAN) 201. The MAC addresses intrinsically assigned to the computers connected to the LAN 201 are used for communication by each computer on the LAN 20. The DHCP server 202 transmits TCP/IP setting or configuration information to the recognized client 203 which has requested connection to the LAN 201. The recognized client 203 receives this setting information and automatically establishes an address in the TCP/IP network environment on the LAN 201 using this setting information. If a client that is not authorized to use the LAN 201 requests the TCP/IP setting information from the DHCP server 202 the monitoring apparatus 13 monitors the LAN 201 and identifies this client by referring to the MAC address of this communication and executes an authentication procedure. An authorized client 203 that is authorized to use the LAN 201 is previously provided with an authentication program 205. The client's authentication program 205 executes the authentication depending on the authentication request of the monitoring apparatus 13. When the monitoring apparatus 13 determines that the authentication provided by the authentication program 205 is correct, the monitoring apparatus 13 stores the MAC address of the client 203 and thereafter does not execute an authentication query even if the client 203 requests the setup of TCP/IP to the DHCP server 202. Since the authentication program 205 is not provided for the unauthorized client 204, the monitoring apparatus 13 cannot authenticate the unauthorized client. Therefore, the monitoring apparatus 13 can determine that the unauthorized client 204 has been connected illegally to the LAN 201 and notifies the LAN manager of the unauthorized connection. As a result, the LAN manager can detect an unauthorized client 204 illegally using the LAN 201.

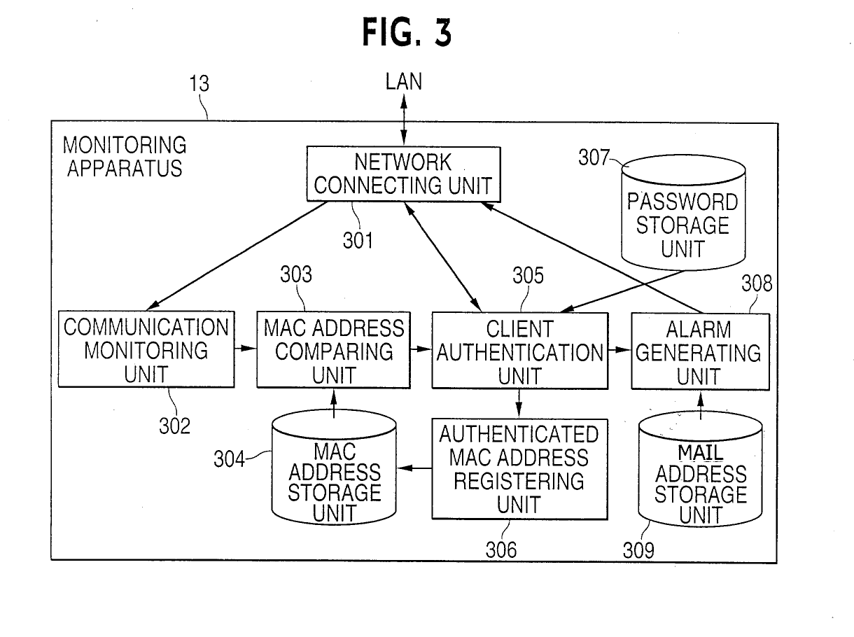

FIG. 3 shows a structure diagram of the monitoring apparatus 13 of an embodiment of the present invention. The monitoring apparatus 13 is connected to the LAN 201 via a network connection unit 301. A communication monitoring unit 302 monitors TCP/IP communication packets with which a client 203 requests the TCP/IP setting information from the DHC server 202 (shown in FIG. 2) via the network connection unit 301. A MAC address storage unit 304 stores the MAC address of the client 203 that is acknowledged by a manager of the LAN 201 to use this LAN network 201.

A MAC address comparing unit 303 compares the MAC address of the transmission originator of the communication packet received by the communication monitoring unit 302 with the MAC address stored in the MAC address storage unit 304. When any one of the MAC addresses stored in the MAC address storage unit 304 matches the MAC address of the transmission terminal in the communication packet, the MAC address comparing unit 303 determines that the client 203 having this MAC address as the transmission terminator is already authorized to conduct a communication. A client authentication unit 305 executes an authentication of the client 203 when the MAC address comparing unit 303 determines that the client 203 is not yet authorized to conduct a communication.

A password storage unit 307 determined by a manager of the LAN 201 stores a password, which is used by a client authentication unit 305 for authentication of the client 203. An authenticated MAC address registering unit 306 additionally registers the MAC address of the client 203 which is authenticated successfully by the client authentication unit 305 to the MAC address storage unit 304. A mail address storage unit 309 stores a mail address of a manager of the LAN 201. An alarm issuing unit 308 notifies the manager using the mail address stored in a mail address storage unit 309, when the client authentication unit 305 cannot authenticate the client 203 indicating that an unauthorized client is using the LAN 201.

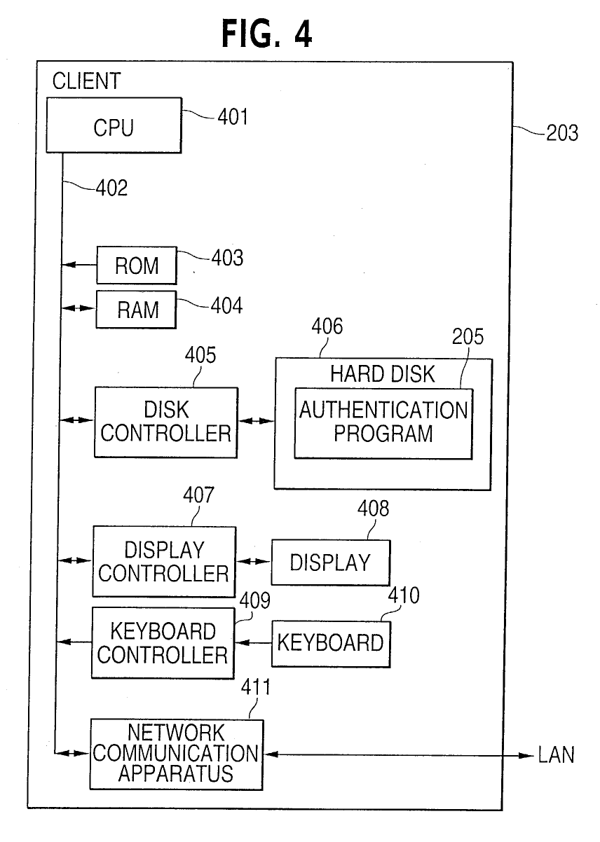

FIG. 4 shows a schematic diagram structure of a client 203 in the present invention. The client 203 includes a central processing unit (CPU) 401 connected with an internal bus 402. The CPU 401 executes an authentication program 205 in response to an authentication request from the monitoring apparatus 13. The internal bus 402 connects to a disk controller 405 and a hard disk 406 using magnetic disks. The hard disk 406 stores an operating system (OS) (not illustrated), programs (not illustrated) operating on the OS, and an authentication program 205. The authentication program 205 may be supplied through a medium such as floppy disk, CDROM, etc. The authentication program also may be stored in the hard disk 206 when the client 203 is manufactured. The internal bus 402 is also provided with a read only memory (ROM) 403 storing a basic input/output system (BIOS) to store the instructions to process the basic input/output processes of the client 203 and a random access memory (RAM) 404 to temporarily store and hold data. The OS and programs operating on the OS are read from the hard disk 405 to RAM 404 and are then executed with the CPU 401. A display 408 is connected via a display controller 407 and this display controller 407 displays image data on the display 408. A keyboard 410 is connected via a keyboard controller 409. In addition, the internal bus 402 is provided with a network communication apparatus 411 connected to the LAN 201. The network communication apparatus is provided with a unique MAC address with which the monitoring apparatus 13 can identify each client 203.

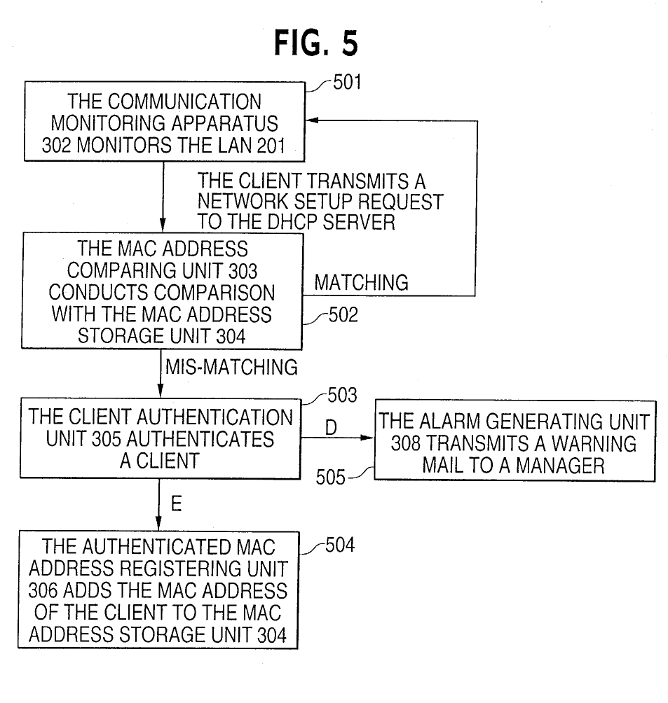

FIG. 5 shows a flowchart of the monitoring method. The communication monitoring unit 302 uses the network connection unit 301 to monitor the TCP/IP communication packet with which the client 203 connected to the LAN 201 requests TCP/IP setting information or configuration information from the DHCP server 202. The monitored communication packet is a DHCPDISCOVER message or similar message (operation 501). The MAC address comparing unit 303 compares the MAC address of the transmission originator of the communication packet with the MAC addresses of clients 203 stored in the MAC address storage unit 304 that have been acknowledged to use the LAN 201, (operation 502). The client 203 having the MAC address of the transmission originator is judged to be acknowledged to use the LAN 201 if the MAC address is stored in the MAC address storage unit 304. In this case, the process returns to operation 501 to monitor the next communication packet. If the MAC address of the transmission terminator is not stored in the MAC address storage unit 304, the client 203 must be authenticated. (operation 503) The client authentication unit 305 communicates with the client 203 using the MAC address of the transmission originator and the client 203 executes the authentication program 205. The authentication program 205 requests that a user input a password determined by a LAN manager and a user of the client 203. The client 203 then transmits the password to the monitoring apparatus 13 via an input/output device. The client authentication unit 305 receives this password and the client 203 is acknowledged to use the LAN 201 when the password is correct. Upon entering the correct password, the MAC address of the authenticated client 203 is also stored to the MAC address storage unit 304 (operation 504), Since the MAC address is stored in the MAC address storage unit 304, the monitoring apparatus 13 does not conduct another authentication of the client 202 even if the client 203 transmits again the communication packet to request the TCP/IP setting information. If the authentication program 205 cannot be executed by the client authentication unit 305, if there is an error in the password received by the client authentication unit 305, or if the password is not returned after an established time-out period, the monitoring apparatus 13 determines that the client 203 is an unauthorized client. At this time, a warning mail is issued to the LAN manager e-mail address, stored in the mail address storage unit, which includes the MAC address of the transmission terminator. (operation 505). In this embodiment, the communication monitoring unit 302 monitors the communication packet to request the TCP/IP setting information issued to the DHCP server 202 from the client 203 and monitors the communication packets about the particular services. All communication packets flowing through the LAN 201 may also be monitored. The monitoring apparatus 13 may transmit a warning to the manager that may be a display image output to the monitoring apparatus 13 to display the warning message.

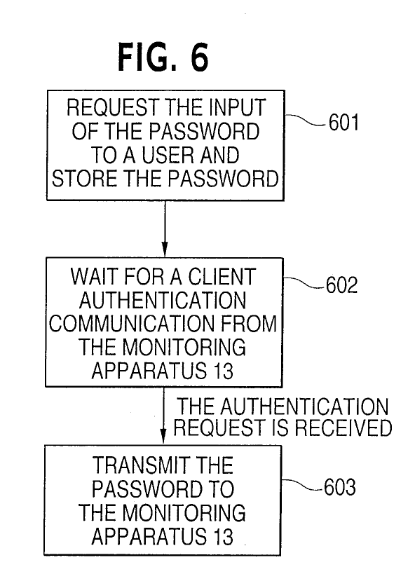

FIG. 6 shows a flowchart of the authentication method 205 embodied in a program. The authentication program 205 is read into the RAM 404 from the hard disk 406 when the client 203 is prompted or connected to the LAN 201, which is then executed by the CPU 401. When the authentication program 205 is executed, the program requests the user to input the password. When the password is input using the keyboard 401, the password is stored in the RAM 404 or hard disk 406 (Step 601).

The authentication program 205 subsequently monitors the TCP/IP communication packets on the LAN 201 using the network communication apparatus 411 and waits for authentication of the client from the monitoring apparatus 13 (operation 602). When client authentication is requested, the authentication program 205 transmits the password to the monitoring apparatus 13 (operation 603).

When the monitoring apparatus 13 authenticates the client 203 successfully, the MAC address of the network communication unit apparatus 411 is stored in the MAC address storage unit 304 and authentication of the client 203 by the client authentication unit 305 is no longer conducted. Therefore, running the authentication program 205 is no longer necessary. The authentication program 205 requests input of the password for authentication when it is prompted, and also may request that the user input of a password when the monitoring apparatus 13 has issued a request for authentication of the client 203 in operation 602. If the password is not provided, the client 203 may be authenticated by the process that the client authentication unit 305 confirms that the authentication program 205 is executed by the client 203. Since the authentication program is not provided for an unauthorized client 204, use of the LAN 201 by an unauthorized client 204 can be controlled.

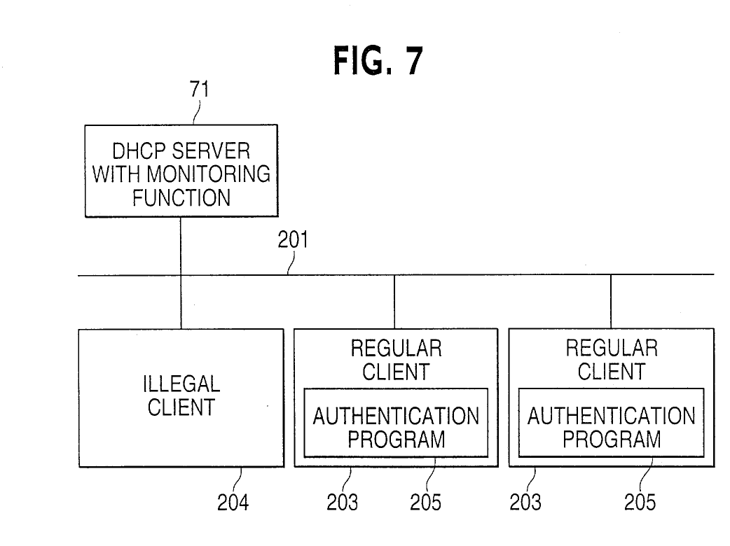

FIG. 7 is a schematic diagram of another embodiment of the present invention. The LAN 201, client 203, unauthorized client 204, and authentication program 205 are similar to that of the embodiment described above. The DHCP server 71 with the monitoring function authenticates a client 203 that has issued a request for connection to the LAN 201 and executes the automatic TCP/IP setting information for the authorized client 203. The client 203 utilizes the TCP/IP service on the LAN 201 without execution of the authentication procedure that provides the TCP/IP setting information. As a result, the DHCP server 71 controls use of the LAN 201 for an unauthorized client 204 which cannot be authenticated.

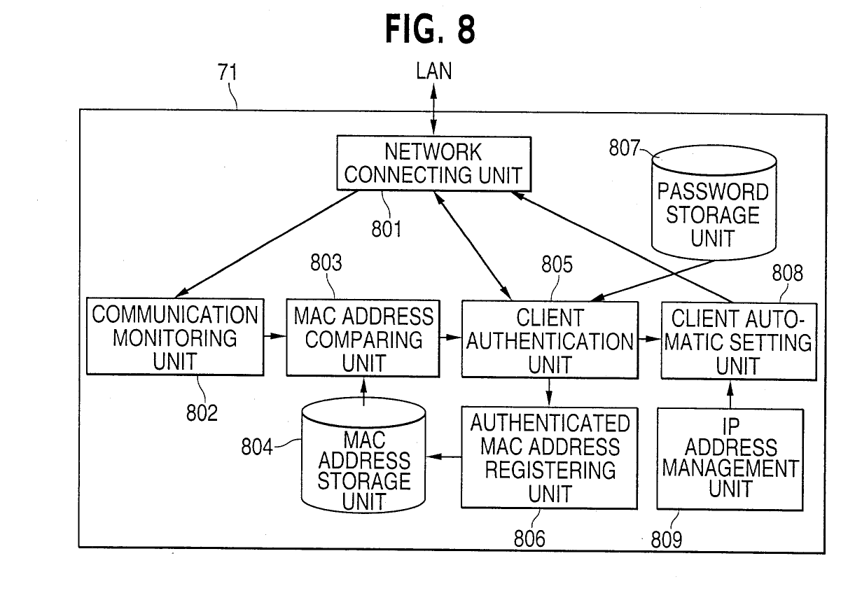

FIG. 8 shows a schematic diagram of the DHCP server 71 with monitoring function described in the second embodiment. The DHCP server 71 is connected to the LAN 201 via the network connection unit 801. The communication monitoring unit 802 receives the TCP/IP communication packet from the client 203 requesting the TCP/IP setting information from the DHCP server 202 via the network connection unit 801. The MAC address storage unit 804 stores the MAC addresses of clients 203 that are acknowledged or authorized to use the LAN 201 by the LAN manager. The MAC address comparing unit 803 compares the MAC address of the transmission terminator issuing the communication packet with the MAC addresses stored in the MAC address storage unit 804. The MAC address comparing unit 804 can identify the MAC address of the client 203 from the communication packet received by the communication monitoring unit 802. When the comparing unit 804 determines that the MAC address is stored in the MAC address storage unit 804, the relevant client 203 is known to have been already authorized to conduct a communication. If the client 203 is not yet approved to conduct a communication by the MAC address comparing unit 803, the client authentication unit 805 executes an authentication of the client 203. The password storage unit 807 stores the passwords which are determined by a manager of the LAN 201 and used for authentication of client 203. The MAC address registering unit 806 registers the MAC address of a client 203 that is successfully authenticated by the client authentication unit 805 by storing the MAC address in the MAC address storage unit 804. An IP address management unit 809 manages IP addresses for the client 203. The unique IP address is assigned to the client 203. A client automatic setting unit 808 conducts an automatic setting communication for the MAC address, together with the IP address preset by the IP address management unit, if the client 203 is successfully authenticated by the client authentication unit 805. The client automatic setting unit 808 does not execute the automatic setting for an unauthorized client 204 that is not successfully authenticated by the client authentication unit 805. Therefore, an unauthorized client 204 cannot use the LAN 201.

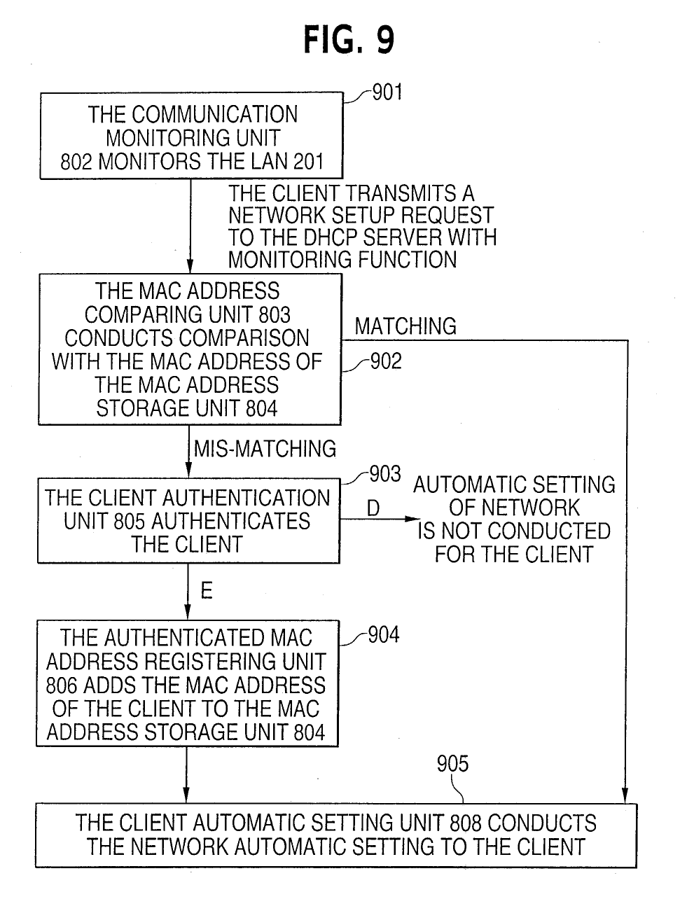

FIG. 9 shows a flowchart of a method of monitoring with the DHCP server 71. The communication monitoring unit 802 uses the network connecting unit 801 to monitor the communication packet sent by the client 203 to request the TCP/IP setting information from the DHCP server 71 (operation 901). The communication packet is referred to as a DHCPDISCOVER message. When the communication monitoring unit 802 detects that the communication packet is transmitted to the LAN 201, the MAC address comparing unit 803 compares the MAC address of the transmission originator of the communication packet with the MAC addresses stored in the MAC address storage unit 804 of the clients 203 that are approved to use the LAN 201 (operation 902). When the MAC address of the transmission originator is stored in the MAC address storage unit 804, the client 203 having the MAC address of the transmission originator is determined to have been previously approved to use the LAN 201. If the MAC address of the transmission originator is not yet stored in the MAC address storage unit 804, the client 203 is authenticated (operation 903).

The client authentication unit 805 makes a communication with the client 203 of the MAC address of the transmission originator and the client 203 executes the authentication program 205. The authentication program 205 urges a user to input the password determined between the LAN manager and a user of the client 203 via an input/output apparatus and then transmits the inputted password to the DHCP server 71. If the password received by the client authentication unit 805 is correct, the client 203 can use the LAN 201. The MAC address of the authenticated transmission originator is also stored in the MAC address storage unit 804 (operation 904). When the MAC address is stored in the MAC address storage unit 804, the DHCP server 71 with monitoring function no longer authenticates the client 203 again even when the client 203 transmits the TCP/IP setting information communication packet again to request connection to the LAN 201. If the client authentication unit 805 cannot execute the authentication program 205, if there is an error in the password received by the client authentication unit 805, or if the password is not returned within a certain time period, the DHCP server 71 determines that the client 203 is an unauthorized client. When the DHCP server 71 with monitoring function determines that the client 203 is a regular client, the IP address management unit 809 assigns the unique address to the client 203 and the client automatic setting unit 808 transmits the IP address and the setting information required for connection of the client 203 to the TCP/IP such as a subnet mask, DNS (Domain Name Server) or the like to the MAC address(operation 905).

As explained above, according to the present invention, an authentication program is prepared for each client and the monitoring apparatus is connected to the network. Use of the network by an unauthorized client can be prevented effectively without individual settings for each client, thereby improving network security.

What is claimed is:

1. A communication monitoring apparatus monitoring communications of a computer network having unique identifiers, comprising:
a communication monitoring unit monitoring communication of computers in the computer network;
an identifier storage unit storing identifiers of computers in the computer network;
an identifier comparing unit comparing the identifier of the computer in the monitored communication with the identifiers of computers stored in the identifier storage unit;
an authentication executing unit executing an authentication procedure with the computer in the monitored communication if the identifier of the computer is not stored in the identifier storage unit; and
an alarm issuing unit issuing a notification that an unauthorized computer has conducted a communication when the computer cannot be authenticated as a result of authentication executed by the authentication executing unit.

2. A communication monitoring apparatus according to claim 1, wherein if the computer is correctly authenticated by the authentication executing unit, the identifier of the computer is stored within the identifier storage unit as the identifier of an authorized computer.

3. A method of monitoring communications between a plurality of computers having unique identifiers, comprising:
monitoring communications of a computer;
comparing an identifier of the computer in the monitored communication with identifiers stored in a storage unit;
authenticating the computer by communication with the computer if the comparing determines that the identifier of the computer is not stored in the storage unit; and
issuing an alarm that an unauthorized computer has conducted a communication if the computer cannot be authenticated.

4 A communication management apparatus transmitting communication setting information to a computer having a unique identifier, comprising:
a communication unit receiving a communication setting request from the computer and transmitting setting information to the computer;
an identifier storage unit storing identifiers of computers permitted to conduct communications;
a communication comparing unit comparing an identifier of the computer issuing the communication setting request to the stored identifiers; and
an authentication executing unit conducting communication with the computer and the communication comparing unit to authenticate the computer if the identifier of the computer is not stored in the identifier storage unit;
wherein the setting information is not transmitted to the computer if the computer is not correctly authenticated.

5. A program that controls a computer in communication with a plurality of computers using unique identifiers to execute:
a communication procedure receiving a request for authentication to confirm that the identifier indicates a regular communication partner; and
an authentication sequence executed in response to the request for authentication.

6. A monitoring apparatus monitoring communications of computers having unique identifiers, comprising:
a communication monitoring unit monitoring communication of a computer;
an identifier storage unit storing identifiers of computers acknowledged to conduct a communication;
an identifier comparing unit comparing an identifier of the computer in the monitored communication with the stored identifiers;
an authentication executing unit executing an authentication procedure if the identifier of the computer in the monitored communication is not stored in the identifier storage unit; and
an alarm issuing unit issuing a notification of an unauthorized computer if the computer in the monitored communication cannot be authenticated.

7. The communication monitoring apparatus of claim 6, wherein the identifier of the computer in the monitored communication is stored in the identifier storage unit as the identifier of a computer authorized to conduct a communication if the authentication executing unit successfully authenticates the computer.

8. The communication monitoring apparatus of claim 7, further comprising a communication management unit, wherein the monitored communication includes a request issued by the computer to the communication management unit to set up setting information for the computer to conduct authorized communication.

9. The communication monitoring apparatus of claim 6, further comprising a communication management unit, wherein the monitored communication includes a request issued by the computer to the communication management unit to set up setting information for the computer to conduct authorized communication.

10. A method of monitoring communications among a plurality of computers having unique identifiers, comprising:
monitoring communication of the computers;
comparing an identifier of a computer in the monitored communication to stored identifiers;
executing an authentication procedure on the identifier of the computer in the monitored communication if the identifier is not one of the stored identifiers; and
issuing notification that an unauthorized computer has conducted a communication if the computer cannot be authenticated.

11. The method of claim 10, wherein if the identifier of the computer in the monitored communication is not stored with the stored identifiers, then further comprising:
authorizing the computer in the monitored communication to communicate; and
storing the identifier of the authorized computer with the stored identifiers.

12. The method of claim 11, wherein the monitoring communication monitors only a request by the computer to set up setting information for the computer to conduct authorized communication.

13. The method of claim 10, wherein the monitoring communication monitors only a request by the computer to set up setting information for the computer to conduct authorized communication.

14. A program controlling a computer, comprising:
a communication monitoring sequence monitoring communications of a plurality of computers having unique identifiers;
an identifier comparing sequence comparing an identifier of a computer in a monitored communication with stored identifiers acknowledging authority to conduct communication;
an authentication executing sequence executing an authentication procedure on the computer if the identifier of the computer included in the communication is not one of the identifiers; and
an alarm issuing sequence issuing a notification that an unauthorized computer has conducted a communication if the computer cannot be authenticated.

15. The program of claim 14, further comprising a storing sequence that stores the identifier of the computer in the identifier storage unit as the identifier of the computer acknowledged to conduct a communication if the computer is successfully authenticated.

16. The program described in claim 15, wherein the communication monitoring sequence monitors only a communication setting request by the computer to a communication management unit.

17. The program described in claim 14, wherein the communication monitoring sequence monitors only a communication setting request by the computer to a communication management unit.

18. A communication management apparatus transmitting a communication setting to computers having unique identifiers, comprising:
a communication unit receiving a setup request communication from a computer and transmitting a setting information required communication to the computer;
an identifier storage unit storing identifiers of computers acknowledged to conduct a communication;
a communication comparing unit comparing the identifier of the computer having issued the setup request with the stored identifiers; and
an authentication executing unit submitting an authentication query communication to the computer via the communication unit to authenticate the computer if the communication comparing unit determines that the identifier of the computer is not one of the stored identifiers;
wherein, if the authentication executing unit does not successfully authenticate the computer, the setting information required for communication is not transmitted to the computer.

19. The communication management apparatus of claim 18, wherein the identifier of the computer is stored in the identifier storage unit as one of the identifiers of computers authorized to conduct communication if the computer satisfies the authentication query.

20. A communication management method transmitting communication setting information to a plurality of computers having unique identifiers, comprising:
receiving a setup request from a computer;
comparing an identifier of the computer issuing the setup request with stored identifiers of computers authorized to conduct communication;
executing an authentication query if the identifier of the computer is not one of the stored identifiers;
transmitting communication setting information to the computer if the computer is successfully authenticated.

21. The communication management method of claim 20 further comprising storing the identifier of the computer as one of the stored identifiers if the computer is successfully authenticated.

22. A program controlling a computer, comprising:
a communication sequence receiving a communication setup request from a plurality of computers having unique identifiers;
a communication comparing sequence comparing an identifier of the computer issuing the setup request with identifiers stored in an identifier storage unit;
an authentication executing sequence communicating with the computer to conduct an authentication if the identifier of the computer is not stored in the identifier storage unit; and
a communication setting sequence transmitting setting information required for communication to the computer if the computer is successfully authenticated.

23. The program of claim 22 further comprising a storing sequence storing the identifier of the computer as one of the stored identifiers if the computer is successfully authenticated.

24. A computer communicating with other computers using unique identifiers, comprising:
a communication unit in communication with a monitoring unit; and
an authentication unit conducting an authentication in response to an authentication request from the monitoring unit, wherein the authentication unit conducts the authentication and transmits a message indicating that the computer using the unique identifier is a regular communication partner with the communication unit if the communication unit receives an authentication message from the authentication unit to confirm that the identifier indicates a regular communication partner.

25. A method of communicating with a plurality of computers using unique identifiers, comprising:
receiving a request from a communication monitoring unit to authenticate an identifier that indicates a regular communication partner; and
executing an authentication procedure in response to the authentication request.

26. A program controlling a computer communicating with a plurality of computers using unique identifiers, comprising:
a communication sequence receiving a request of authentication to confirm that the identifier indicates a regular communication partner from a communication monitoring unit; and
an authentication sequence executing an authentication in response to the authentication request from the communication monitoring unit.

27. A method of performing a network communication, comprising:
determining whether a computer is authorized to communicate over a network;
performing an authentication with the computer responsive to the determining; and
allowing communication over the network by the computer if the computer is one of an authorized and authenticated computer.

28. A method as recited in claim 27, wherein said computer has a unique identifier and said determining compares the identifier of the computer with an authorized computer identifier and indicates authorization when there is a match.

29. A method as recited in claim 28, further comprising setting the authorized computer identifier to match the unique identifier when the computer is authenticated.

30. A method as recited in claim 27, further comprising issuing an alarm if the computer is not authorized or authenticated.
